(19) United States
(12) Patent Application Publication
(10) Pub. No.: US 2014/0076118 A1
(43) Pub. Date: Mar. 20, 2014

(54) DEVICE FOR THE TRANSVERSE CUTTING OF CELLULOSE-PULP BANDS

(71) Applicants: Sergio Sanchez Pasaban, Tolosa (ES); Javier Francisco Otaño Pagola, Tolosa (ES)

(72) Inventors: Sergio Sanchez Pasaban, Tolosa (ES); Javier Francisco Otaño Pagola, Tolosa (ES)

(73) Assignee: Pasaban, S.A., Tolosa, Guipuzcoa (ES)

(21) Appl. No.: 14/113,777

(22) PCT Filed: Apr. 28, 2011
(86) PCT No.: PCT/ES2011/070304

§ 371 Date: Dec. 4, 2013

(51) Int. Cl. B26D 1/22

(52) U.S. Cl. CPC B26D 1/225
USPC 83/591

(57) ABSTRACT

Device for the transverse cutting of cellulose-pulp bands that comprises a first transverse-cut rotating roller (1) with at least a first cutter (2) and a second transverse-cut rotating roller (3) with at least one fixed cutter (4a) and at least one retractable cutter (4b); the cutters (2, 4a, 4b) being arranged in respective positions such that in the cutting position thereof they coincide, upon rotation of the rollers (1, 3) on a transverse-cut line perpendicular to the direction of forward movement of a cellulose-pulp band (5) moving between the rollers (1, 2); a retraction mechanism (6) that allows the retractable cutter (4b) to be moved between a cutting position, in which the retractable cutter projects radially from the outer surface of the second roller (3) as far as a cutting line, and a retracted position, in which the retractable cutter (4b) is radially retracted from said cutting line.

### TECHNICAL FIELD OF THE INVENTION

The present invention is comprised in the technical field of the paper industry, particularly in the sector of paper manufacturing machines, and more particularly cutting devices for cutting cellulose pulp webs.

### BACKGROUND OF THE INVENTION

As is known, paper is manufactured from cellulose pulp webs obtained from the corresponding raw materials. Cellulose pulp webs, which usually have a thickness of about 2 mm, are transversely cut into pieces of determined lengths by means of a transverse cutting device to obtain sheets or laminas of a determined width. The cut sheets will serve for the manufacture of paper, cardboard, etc. in separate production lines. On many occasions, the lines for obtaining pulp, where the transverse cutting device is integrated, are located in pulp production plants, generally in countries where its raw materials can be found, such as Brazil, Uruguay, Argentina, Chile, Canada, Norway, etc., whereas paper mills are distributed all over the world.

The transverse cutting of cellulose pulp is traditionally done by means of devices comprising a rotating blade incorporated in a cylinder with a shaft operated by one or several motors and a swage or counter-blade arranged in the part opposite the blade. A transverse cut is made in the cellulose pulp web with each turn of the blade. As the cellulose pulp web moves forward at a determined speed, the rotation of the blade is synchronized in order to make transverse cuts at a constant determined length to obtain pieces of cellulose pulp with a determined length, the cut length also depending on the linear development of the cylinder. The transverse cut is made continuously as the cellulose pulp passes. The main problem with this transverse cutting of the pulp is that the thickness of the cellulose pulp is relatively large (about 2 mm), and that the cellulose pulp is flexible, such that the cut of the blade presses the material and causes quality defects known in the sector as fish-eye. Furthermore, every time the machine stops, the roller holding the blade or blades contracts, so in some cases it is necessary to heat the blade in order to start a new cutting cycle.

To solve this problem, there are synchronous transverse cutting devices comprising two rollers each facing a blade, such that the rotation of both rollers occurs such that the blades coincide at one point and make a transverse cut in the cellulose pulp web, similar to that of scissors. Higher quality transverse cuts are thus achieved which do not have the problems mentioned in relation to the devices formed by a blade and swage (counter-blade). To that end, each roller can be arranged in an axis that is not perpendicular to the forward movement direction of the cellulose pulp web, and the blade is arranged forming an axial helical segment extending from one end of the roller to the other. This combination allows the cut to be transverse to the forward movement. Each roller can incorporate more than one blade to adapt the position of the transverse cut to the required lengths of the sheet (laminas). With this system, it is not necessary to heat the blades since the scissor-type cut makes one blade penetrate another and contact is not lost even though the rollers are cooled and slightly contracted. The service life of the blades is also longer, a smaller foundation is required for the machine and the cut produces less dust.

The inherent problem both in transverse cutting devices formed by a blade and swage or counter-blade and in synchronous transverse cutting devices is that the movement of the roller incorporating the blade or blades and the rate of travel of the cellulose pulp web determine the position of the cut and therefore the length of the pieces of cellulose pulp obtained. In the event that there is more than one blade in the roller, a not excessively high roller speed obtains the necessary cut. To that respect, it must be taken into account that these rollers can be up to 10 meters long, so it is not easy to make them rotate at high speeds since they require very powerful and high energy consumption drive motors, such that adjusting the length of the pieces of cellulose pulp by means of accelerating and decelerating the rotational speed of the rollers is disadvantageous from both an energy and a mechanical point of view. To solve this problem, cutting rollers incorporated several blades can be used such that when a blade is disassembled from one of the rollers, when the corresponding blade of the other roller arrives the cut is not made. For example, if there are two blades in each roller, two cuts could be made in each turn of roller, or if one of the blades is removed, one cut is made per turn. Obviously the problem is that it is necessary to remove the roller and disassemble the blade to change the cut length.

### DESCRIPTION OF THE INVENTION

The object of the present invention is to overcome the drawbacks of the state of the art described above by means of a transverse cutting device for cutting cellulose pulp webs comprising a first rotating cutting roller in which there is assembled at least a first blade radially projecting from the outer surface and between the ends of the first rotating roller, and a second rotating transverse cutting roller in which there are assembled at least two second projecting blades, in cutting position, projecting from the outer surface and arranged between the ends of the second rotating roller; the rotating rollers are assembled in respective coaxial rotating shafts driven by at least one drive motor; the blades being arranged in respective positions such that they coincide in their cutting position upon rotation of the rollers in a transverse cutting fine, perpendicular to the forward movement direction of a cellulose pulp web (5) which is travelling between the rollers; characterized in that at least one of the second blades is a fixed blade assembled in one of the rollers in a fixed position; at least another one of the second blades is a retractable blade assembled in the other roller by means of a retraction mechanism which allows shifting the retractable blade between a cutting position in which the retractable blade radially protrudes from the outer surface of the roller to said cutting line and a retracted position in which the retractable blade is radially retracted from said cutting line.

According to the invention, the first blades can be two fixed blades axially arranged in respective diagonally opposite peripheral locations of the first rotating roller, whereas the second blades can be a fixed blade and a retractable blade axially arranged in respective diagonally opposite peripheral locations of the second rotating roller. Naturally, regardless of the cutting needs, two or more retractable blades of the type described above can also be provided. It is also possible to arrange one or more additional retractable blades in the first cutting cylinder.

The retraction mechanism can be assembled in an axial cavity in the periphery of the roller and comprise a blade holder plate and at least one thrust plate arranged below the blade holder plate. The blade holder plate and the thrust plate are arranged axially in the axial cavity. The blade holder plate comprises a projecting part which projects towards the periphery of the roller in which there is assembled the retractable blade, an inner surface resting on the thrust plate, and a flexible side flange anchored by its free end part in the axial cavity of the roller. In turn, the thrust plate is housed in an inner part of the axial cavity and comprises an outer surface comprising, in the axial direction, a plurality of axial ramps between which respective straight support sectors are intercalated. The inner surface of the blade holder plate is provided with recesses configured complementarily to the ramps in the outer surface of the thrust plate. On the other hand, the thrust plate is axially shiftable with respect to the blade holder plate between a first position in which the ramps of the thrust plate fit into the recesses of the inner surface of the blade holder plate and the inner surface is seated in the support sectors in the outer surface of the thrust plate, and a second position in which an initial sector of an inclined part of each of the recesses in the inner surface of the blade holder plate is supported on an end sector of each ramp in the outer surface of the thrust plate. The ramps and the recesses are sized such that when the thrust plate is in said first position, the retractable blade is in said retracted position, and when the thrust plate is in said second position, the retractable blade is in said cutting position. In its shifting from the first position towards the second position, the thrust plate must overcome the force exerted in the opposite direction by the flexible flange of the blade holder plate which is gradually bent slightly towards the outer periphery of the rotating roller. Due to its flexibility, the side flange recovers its initial position when the thrust plate returns to the first position, such that the flexible flange maintains the blade holder plate in the retractable blade retracted position, such that the retractable blade is retained in that position despite the incident centrifugal and gravity forces.

In a preferred embodiment of the invention, the inner part of the axial cavity is a channel with a bottom located in a first intersecting plane of the roller, the axial cavity further comprising an anchoring sector located in a second intersecting plane at a closer distance from the periphery of the roller than the first intersecting plane, an axial inner step located between said inner part and said anchoring sector. The side flange is anchored in the anchoring sector, and the thrust plate and the inner surface are located in the aforementioned channel.

According to the preferred embodiment described above, the blade holder plate can comprise an inner body from which the projecting part projects. The side flange extends from that inner body comprising the inner surface of the blade holder plate and the inner body is arranged in said channel. The blade holder plate can further comprise an axial side projection housed in an axial side space of the axial cavity extending in said first intersecting plane towards the periphery of the roller.

A plurality of guide rods perpendicular to the intersecting planes traversing respective through holes in the blade holder plate can be provided, anchored in the thrust plate. These guide rods can comprise at their free ends respective stop elements which prevent, in addition to the axial shifting of the blade holder plate, the blade holder plate from pushing the retractable blade towards a radial position exceeding the cutting line of the cellulose pulp web.

In an especially advantageous embodiment, the coaxial rotating shafts of the rotating rollers are arranged with an angular offset with respect to the transverse cutting line.

As can be inferred from the foregoing, the distance of the transverse cuts of the cellulose pulp web can be effectively adjusted by means of the present invention to obtain pieces of cellulose of different predetermined lengths with a cutting device having a simple and reliable structure.

### BRIEF DESCRIPTION OF THE DRAWINGS

Aspects and embodiments of the invention are described below based on several drawings in which

FIG. 1 is a partially sectioned side elevational schematic view of an installation for preparing sheets or laminas of cellulose pulp in which the device according to the present invention can be integrated;

FIG. 2 is a front perspective schematic view of an embodiment of the cutting rollers according to the present invention;

FIG. 3 is an upper plan schematic view of the first cutting roller shown in FIG. 2 according to a first operating mode of the device according to the present invention;

FIG. 4 is a side elevational schematic view of the cutting rollers shown in FIG. 2 in a first position in which the retractable blade is retracted to operate in the first operating mode illustrated in FIG. 3;

FIG. 5 is a partial enlarged schematic view of the retraction mechanism shown in FIG. 4;

FIG. 6 is a partial rear perspective schematic view of the cutting mechanism shown in FIGS. 4 and 5 in the first operating mode illustrated in FIG. 3;

FIG. 7 is a rear elevational schematic view of the cutting mechanism shown in FIGS. 4 to 6 in the first operating mode illustrated in FIG. 3;

FIG. 8 is a front perspective schematic view of the cutting mechanism shown in FIGS. 4 to 7 in the first operating mode illustrated in FIG. 3; .

FIG. 9 is a partial enlarged schematic view of the retraction mechanism shown in FIG. 8;

FIG. 10 is an upper plan schematic view of the first cutting roller shown in FIG. 2 according to a second operating mode of the device according to the present invention;

FIG. 11 is a side elevational schematic view of the cutting rollers shown in FIG. 2 in a first second position in which the retractable blade is retracted to operate in the first operating mode illustrated in FIG. 10;

FIG. 12 is a partial enlarged schematic view of the retraction mechanism shown in FIG. 11;

FIG. 13 is a partial rear perspective schematic view of the cutting mechanism shown in FIGS. 11 and 12 in the second operating mode illustrated in FIG. 10;

FIG. 14 is a rear elevational schematic view of the cutting mechanism shown in FIGS. 11 to 13 in the second operating mode illustrated in FIG. 10;

FIG. 15 is a front perspective schematic view of the cutting mechanism shown in FIGS. 11 to 14 in the second operating mode illustrated in FIG. 10;

FIG. 16 is a partial enlarged schematic view of the retraction mechanism shown in FIG. 15.

Reference numbers identifying the following elements are seen in these figures;
1 first rotating roller
1a rotating shaft of the first roller
2 first blade
3 second rotating roller
3a rotating shaft of the second roller
4 second blades
4a fixed blade
4b retractable blade
5 cellulose pulp web
5a sheet of cellulose pulp
6 retraction mechanism
7 axial cavity
7a channel
7b anchoring sector
7c side step
7d side space
8 blade holder plate
8a projecting part
8b inner surface
8c flexible side flange
8d recess
8e inner body
8f side projection
8g through hole
9 thrust plate
9a axial ramp
9b support sector
10 guide rods
10a stop element
11 longitudinal cutting disc
12 drive cylinder
A longitudinal beveling station
B drive station
C transverse cutting station
S1 first intersecting plane
S2 second intersecting plane

### EMBODIMENTS OF THE INVENTION

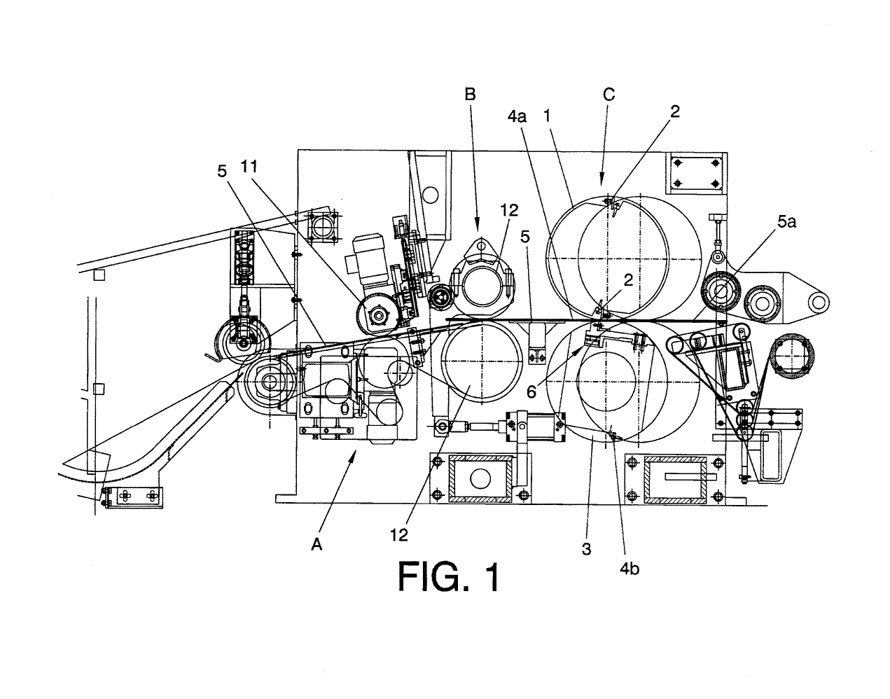

FIG. 1 shows an embodiment of an installation for cutting sheets of cellulose pulp. The cellulose pulp web -5-, driven by drive cylinders -12- of a drive station -B-, is beveled longitudinally in a longitudinal cutting station -A- comprising a series of cutting discs -11-. The beveled web -5- then passes through a transverse cutting station -C- in which the transverse cutting device for cutting cellulose pulp webs to which the present invention relates and in which the cellulose web -5- is cut transversely into sheets -5a- of the desired width is integrated.

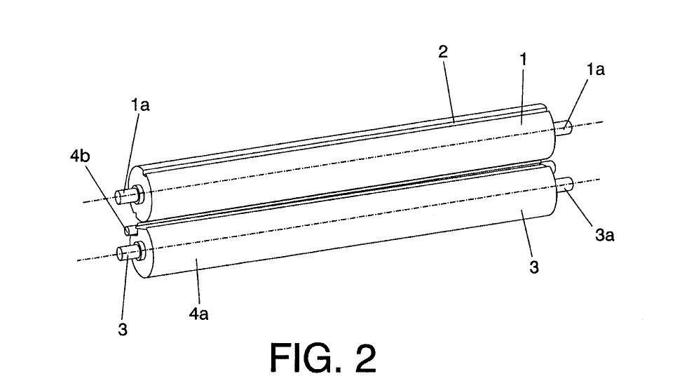

In the embodiment shown in FIGS. 1 and 2, the cutting device -C- comprises a first rotating cutting roller -1- in which there is assembled a first blade -2- radially projecting from the outer surface and between the ends of the first rotating roller -1-, and a second rotating cutting roller -3- in which there are assembled two second projecting blades -4-, in the cutting position, projecting from the outer surface and arranged between the ends of the second rotating roller -3-, The rotating rollers -1, 3- are assembled in respective coaxial rotating shafts -1a, 3a- driven by at least one drive motor, and the blades -2, 4- are assembled in respective positions such that they coincide in their cutting position upon rotation of the rollers -1, 3-, in a transverse cutting line, perpendicular to the forward movement direction of the cellulose pulp -5- which is travelling between the rollers -1, 2-.

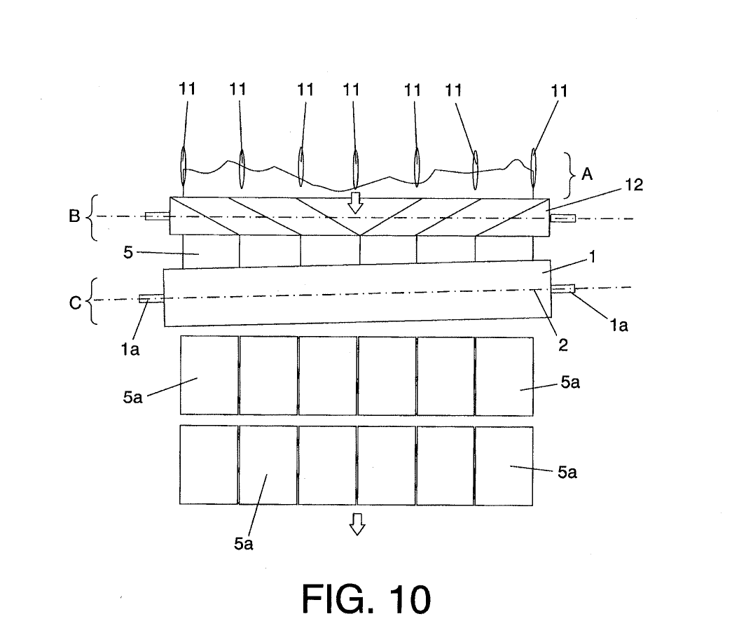

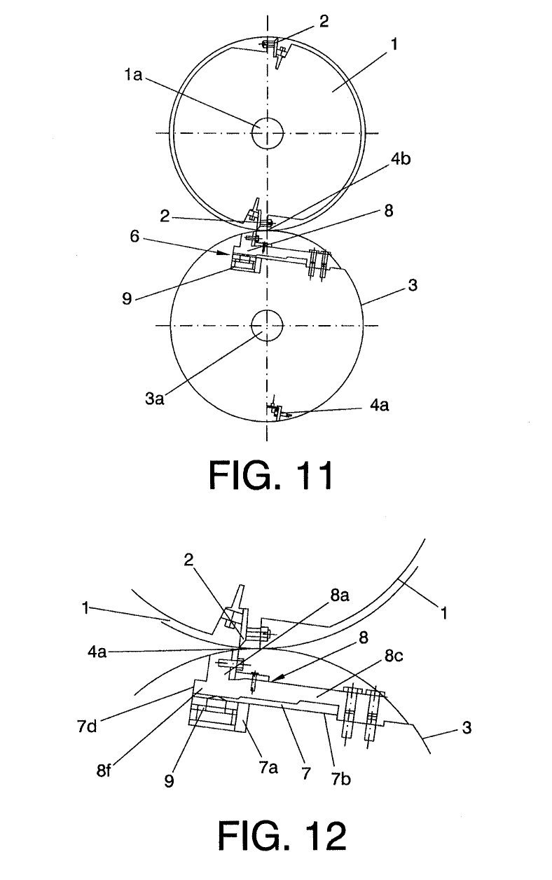

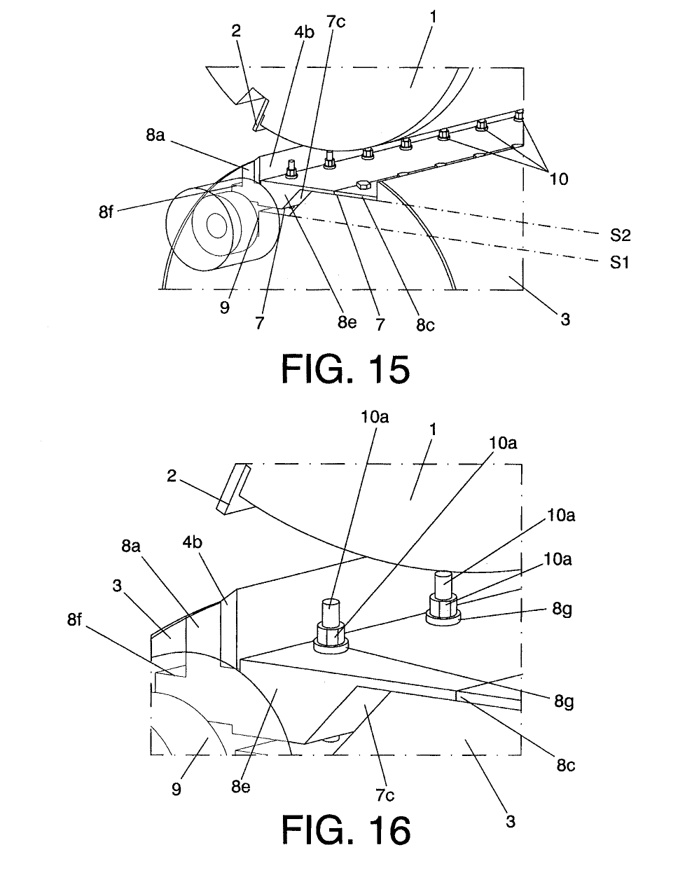

Respective first fixed blades -2- assembled in respective fixed positions are assembled in radially opposite positions in the periphery of the first roller -1-. On the other hand, a second fixed blade -4a- and a retractable blade -4b- are also assembled in radially opposite positions of the second roller -3-. The retractable blade -4b- is assembled in a retraction mechanism -6- which allows shifting the retractable blade -4b- between a cutting position in which it radially protrudes from the outer surface of the roller -3-, see FIGS. 10-16, to said cutting line and a retracted position, see

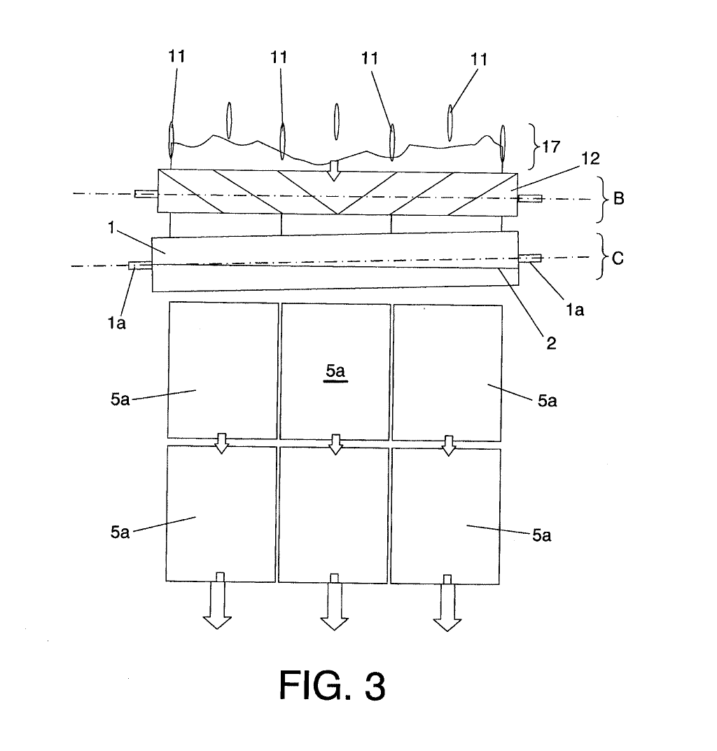

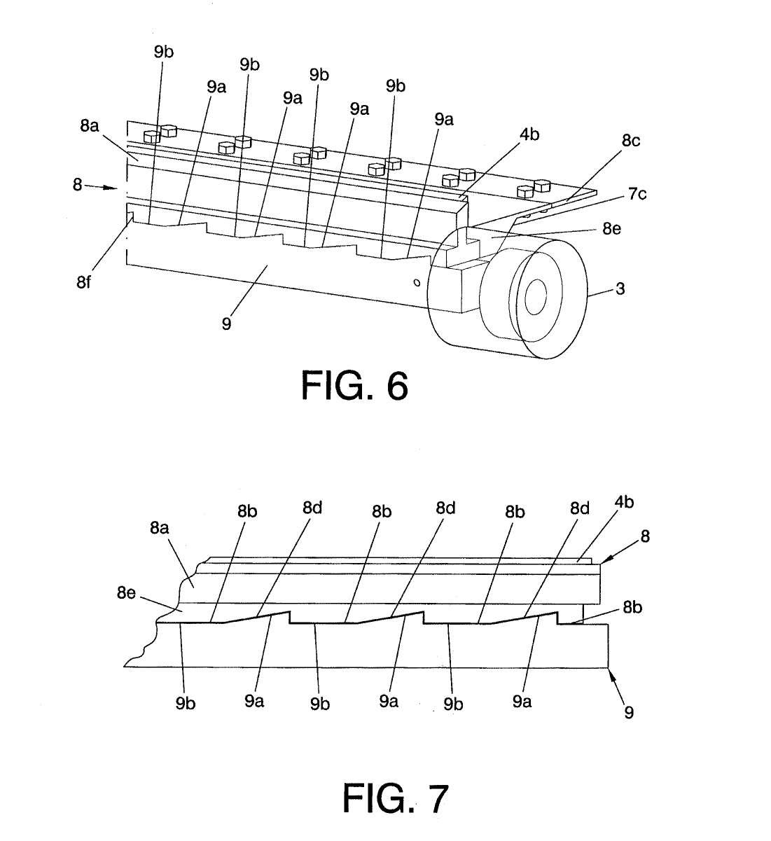

FIGS. 3-9, in which it is radially retracted from said cutting line. As can be seen in FIGS. 2, 3 and 10, the coaxial rotating shafts -1a, 3a- of the rotating rollers -1, 3- are arranged with an angular offset with respect to the transverse cutting line,

FIGS. 3-9 illustrate the transverse cutting device shown in FIGS. 1 and 2 in a first operating mode in which large sheets or laminas of cellulose -5a- are cut. The cellulose pulp web -5- has been beveled longitudinally by the cutting discs -11- at a width of, for example, 1322 mm and the transverse cutting device -C- is used to make transverse cuts giving a length of, for example 1600 mm, to the sheets -5a-, These measurements correspond to a large format commonly used for sheets of cellulose pulp -5a- which serve to manufacture wrapping paper.

As can be seen in FIGS. 3 to 9, the retraction mechanism -6- is assembled in an axial cavity -7- in the periphery of the roller -3- and comprises a blade holder plate -8- and at least one thrust plate -9- arranged below the blade holder plate -8-, the blade holder plate -8- and the thrust plate -9- being axially arranged in the axial cavity -7-. The inner part -7a- of the axial cavity -7- is a channel -7a- with a bottom located in a first intersecting plane -S1- of the roller -3-, and further comprises an anchoring sector -7b- located in a second intersecting plane -S2- at a closer distance from the periphery of the roller -3- than the first intersecting plane -S1-, an axial inner step -7c- located between said inner part -7a- and said anchoring sector -7b-. The side flange -8c- is anchored in said anchoring sector -7b-, and said thrust plate -9- and said inner surface -8b- are located in said channel -7a-. The blade holder plate -8- comprises a projecting part -8a- which projects towards the periphery of the roller -3- in which there is assembled the retractable blade -4b-, an inner surface -8b- resting on the thrust plate -9-, and a flexible side flange -8c-anchored by its free end part in the axial cavity -7- of the roller -3-. The inner surface -8b- of the blade holder plate -8- is provided with recesses -8d- configured complementarily to ramps -9a- arranged in the outer surface of the thrust plate -9-. The thrust plate -9- is housed in an inner part -7a- of the axial cavity -7- and comprises in its outer surface a plurality of the aforementioned axial ramps -9a- between which respective straight support sectors -9b- are intercalated. The blade holder plate -8- also comprises an inner body -8e- from which said projecting part -8a- projects and from which said side flange -8c- extends. The aforementioned inner body -8e- comprises the inner surface -8c- of the blade holder plate -8-, and the inner body is arranged in the channel -7a-. The blade holder plate -8- further comprises an axial side projection -8f- housed in an axial side space -7d- of the axial cavity -7- extending in said first intersecting plane -S1- towards the periphery of the roller -3-.

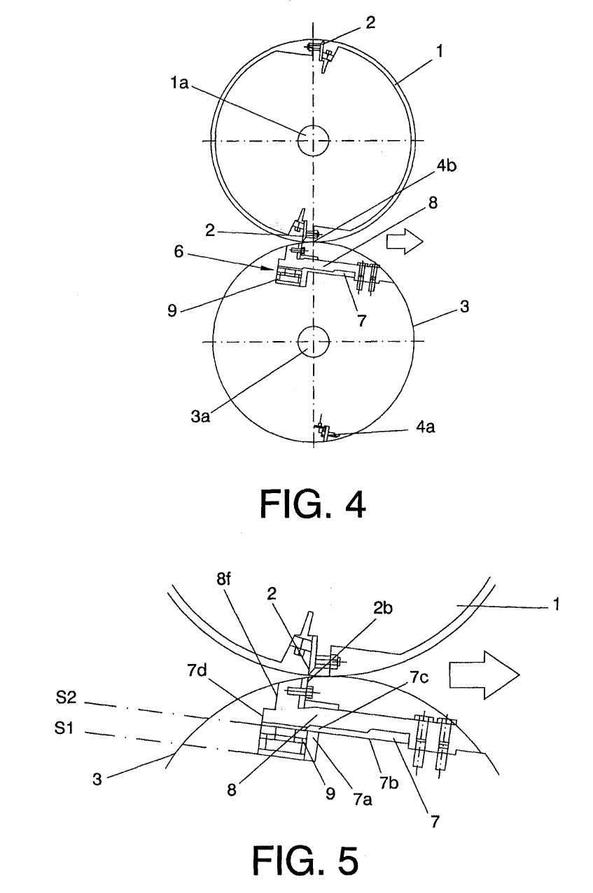

The thrust plate -9- is axially shiftable with respect to the blade holder plate -8- and FIGS. 4 to 9 illustrate the thrust plate -9- in a first position in which the ramps -9a- of the thrust plate -9- fit into the recesses -8d- of the inner surface -8b- of the blade holder plate -8- and the inner surface -8b- is seated in the support sectors -9b- in the outer surface of the thrust plate -8-. The ramps -9a- and the recesses -8d- are sized such that when the thrust plate -9- is in this first position, the retractable blade -4b- is in said retracted position in which it does not reach the transverse cutting line and, therefore, does not make a cut in the cellulose pulp web -5-.

FIGS. 10-16 illustrate the transverse cutting device shown in FIGS. 1 and 2 in a second operating mode in which large sheets of cellulose -5a- are cut. The cellulose pulp web -5- has been beveled longitudinally by the cutting discs -11- at a width of 920 mm and the transverse cutting device -C- is used to make transverse cuts giving a length of 666 mm to the sheets -5a-. Other cutting measurements can be, for example, 690×820 mm, 838×676 mm or 840×770 mm. These measurements, which can include slight variations, correspond to standard formats commonly used for sheets of cellulose pulp -5a- which serve to manufacture sheets of paper.

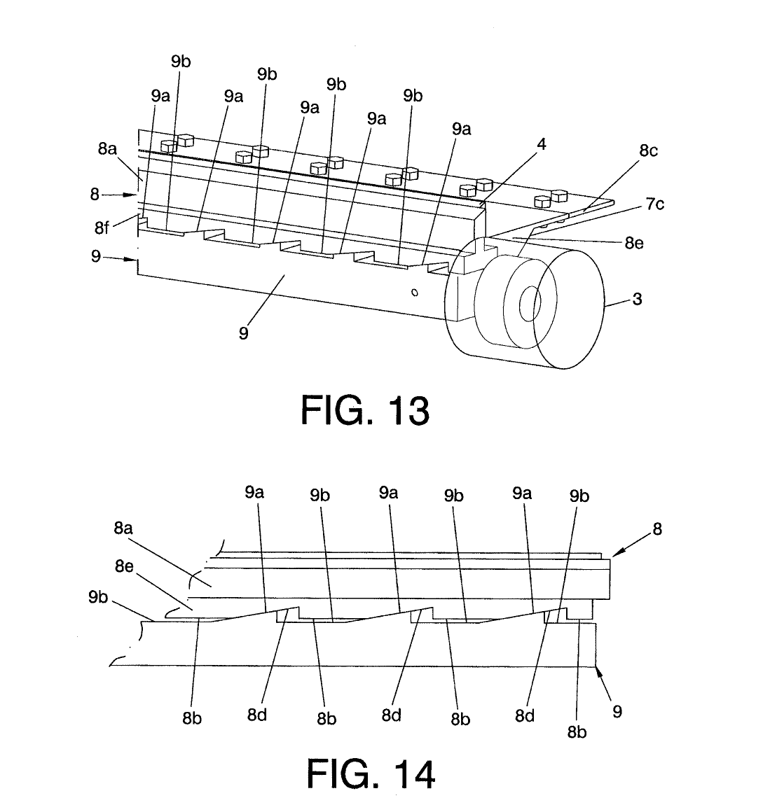

In this second operating mode, the retractable blade is in the aforementioned cutting position, for which the thrust plate has been shifted to a second position, see FIGS. 13-16, in which an initial sector of an inclined part -8b- of each of the recesses -8d- in the inner surface of the blade holder plate -9- is supported on an end sector of each ramp -9a- in the outer surface of the thrust plate -9-, such that when the thrust plate -9- is in this second position, the retractable blade -4b- is in the cutting position. The flexibility of the side flange -8c- allows it to recover its initial position when the thrust plate -9- returns to the first position and the flexible side flange -8c- maintains the blade holder plate -8- in the retractable blade -4b- retracted position, such that the retractable blade is retained in that position despite the incident centrifugal and gravity forces in the second roller -3-.

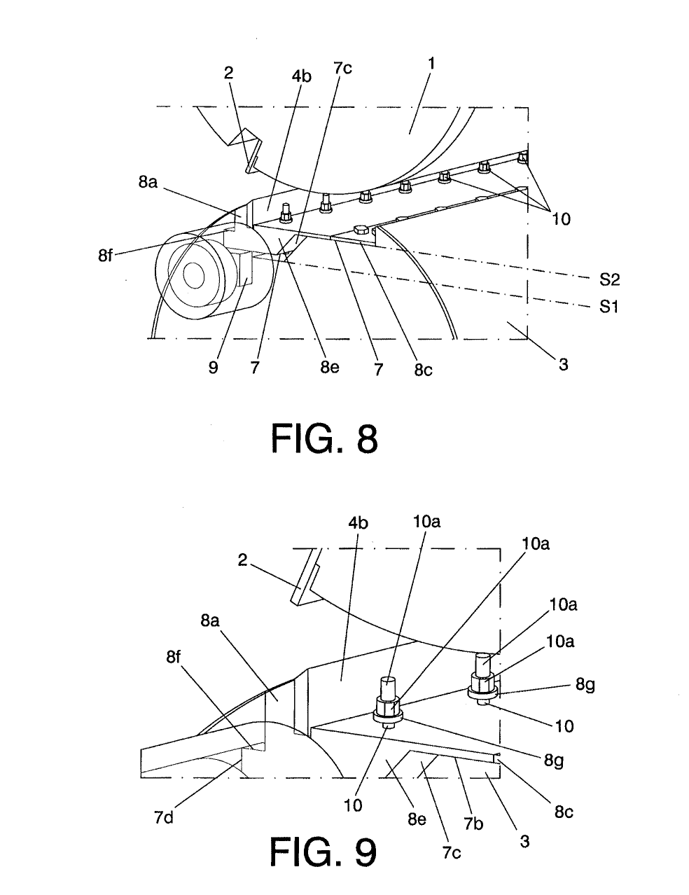

As can be seen in FIGS. 8, 9, 15 and 16, guide rods -10- perpendicular to the intersecting planes -S1, S2- traversing respective through holes -8g- in the blade holder plate -8- are arranged anchored in the thrust plates -9-. These guide rods -10- comprise respective stop elements -10a- at their free ends. The guide rods -10- can be studs, in which case the stop elements -10a- can be double nuts -10a-.

1. Transverse cutting device for cutting cellulose pulp webs comprising
a first rotating cutting roller (1) in which there is assembled at least a first blade (2) radially projecting from the outer surface and between the ends of the first rotating roller (1), and a second rotating cutting roller (3) in which there are assembled at least two second projecting blades (4a, 4b), in cutting position, projecting from the outer surface and arranged between the ends of the second rotating roller (3);
the rotating rollers (1, 3) are assembled in respective coaxial rotating shafts (1a, 3a) driven by at least one drive motor;
the blades (2, 4a-4b) being arranged in respective positions such that they coincide in their cutting position upon rotation of the rollers (1, 3) in a transverse cutting line, perpendicular to the forward movement direction of a cellulose pulp web (5) which is travelling between the rollers (1, 2);
characterized in that
at least one of the blades (2, 4a-4b) is a fixed blade (4a) assembled in a fixed position;
at least another one of the blades (2, 4a-4b) is a retractable blade (4b) assembled in a retraction mechanism (6) which allows shifting the retractable blade (4b) between a cutting position in which it radially protrudes from the outer surface of the roller (3) to said cutting line and a retracted position in which it is radially retracted from said cutting line.

2. Device according to claim 1, characterized in that
the retraction mechanism (6) is assembled in an axial cavity (7) in the periphery of the roller (3) and comprises a blade holder plate (8) and at least one thrust plate (9) arranged below the blade holder plate (8), the blade holder plate (8) and the thrust plate (9) being arranged axially in the axial cavity (7);
the blade holder plate (8) comprises a projecting part (8a) which projects towards the periphery of the roller (3) in which there is assembled the retractable blade (4b), an inner surface (8b) resting on the thrust plate (9), and a flexible side flange (8c) anchored by its free end part in the axial cavity (7) of the roller (3);
the thrust plate (9) is housed in an inner part (7a) of the axial cavity (7) and comprises an outer surface comprising, in the axial direction, a plurality of axial ramps (9a) between which respective straight support sectors (9b) are intercalated;
the inner surface (8b) of the blade holder plate (8) is provided with recesses (8d) configured complementarily to the ramps (9a) in the outer surface of the thrust plate (9);
the thrust plate (9) is axially shiftable with respect to the blade holder plate (8) between a first position in which the ramps (9a) of the thrust plate (9) fit into the recesses (8d) of the inner surface (8b) of the blade holder plate (8) and the inner surface (8b) is seated in the support sectors (9b) in the outer surface of the thrust plate (8), and a second position in which an initial sector of an inclined part (8b) of each of the recesses (8d) in the inner surface of the blade holder plate (9) is supported on an end sector of each ramp (9a) in the outer surface of the thrust plate (9);
the ramps (9a) and the recesses (8d) are sized such that when the thrust plate (9) is in said first position, the retractable blade (4b) is in said retracted position and, when the thrust plate (9) is in said second position, the retractable blade (4b) is in said cutting position.

3. Device according to claim 2, characterized in that
the inner part (7a) of the axial cavity (7) is a channel (7a) with a bottom located in a first intersecting plane (S1) of the roller (3), the axial cavity (7) further comprising an anchoring sector (7b) located in a second intersecting plane (S2) at a closer distance from the periphery of the roller (3) than the first intersecting plane (S1), an axial inner step (7c) located between said inner part (7a) and said anchoring sector (7b);
and in that the side flange (8c) is anchored in said anchoring sector (7b), and said thrust plate (9) and said inner surface (8b) are located in said channel (7a).

4. Device according to claim 3, characterized in that the blade holder plate (8) comprises an inner body (8e) from which said projecting part (8a) projects and from which said side flange (8c) extends, and in that the inner body (8e) comprises the inner surface (8c) of the blade holder plate (8), the inner body being arranged in said channel (7a).

5. Device according to claim 2, characterized in that the blade holder plate (8) further comprises an axial side projection (8f) housed in an axial side space (7d) of the axial cavity (7) extending in said first intersecting plane (S1) towards the periphery of the roller (3).

6. Device according to claim 2, characterized in that it comprises a plurality of guide rods (10) perpendicular to said intersecting planes (S1, S2), traversing respective through holes (8g) in the blade holder plate (8) anchored in the thrust plate (9).

7. Device according to claim 6, characterized in that the guide rods (10) comprise at their free ends respective stop elements (10a).

8. Device according to claim 1, characterized in that the first blades (2) are two fixed blades axially arranged in respective diagonally opposite peripheral locations of the first rotating roller (1).

9. Device according to claim 1, characterized in that the fixed blade (4a) and the retractable blade (4b) are arranged axially in respective diagonally opposite peripheral locations of the second rotating roller (2).

10. Device according to claim 1, characterized in that at least one of the first blades (2) assembled in the first roller (1) is a retractable blade (4b) assembled in an additional retraction mechanism (6).

11. Device according to claim 1, characterized in that the coaxial rotating shafts (1a, 3a) of the rotating rollers (1, 3) are arranged with an angular offset with respect to the transverse cutting line.
